(19) United States
(12) Patent Application Publication
(10) Pub. No.: US 2009/0169184 A1
(43) Pub. Date: Jul. 2, 2009

(54) PORTABLE ELECTRONIC DEVICE

(75) Inventors: LUNG DAI, Tu-Cheng (TW); JIE LIU, Shenzhen City (CN); TIAN-LONG HE, Shenzhen City (CN); TAO WANG, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 12/137,520

(22) Filed: Jun. 11, 2008

(30) Foreign Application Priority Data
Dec. 27, 2007 (CN) 200710203456.8

(51) Int. Cl. H04N 5/00

(52) U.S. Cl. 386/126

(57) ABSTRACT

A portable electronic device includes a main body, a cover, and an infrared receiver. The main body is configured for reading information from an optical disc and generating display signals. The cover is connected to the main body. The screen is configured for receiving the display signals and displaying videos correspondingly. The infrared receiver is arranged at the cover for receiving control signals.

### BACKGROUND

1. Field of the Invention

The present invention generally relates to portable electronic devices, and particularly to a portable digital versatile disc (DVD) player.

2. Description of Related Art

Referring to FIG. 6, a conventional portable digital versatile disc (DVD) player 10 includes a main body 102 and a display 104 pivotally connected to the main body 102. The main body 102 accommodates most of the operating mechanisms, such as a traverse module, an optical pickup head, and functional circuits such as a tracking servo system and focusing servo system. Depending on these operating mechanisms and functional circuits, the main body 102 can read information from an optical disc and generate display signals. The display 104 receives the display signals and displays images or videos correspondingly.

The main body 102 includes an infrared receiver 106 for receiving control signals from a remote controller (not shown). In response to the control signals, the main body 102 can perform a start function, a stop function, a pause function, etc. In order to facilitate remote controls of the portable DVD player 10, the infrared receiver 106 is disposed in a front edge of the main body 102.

Referring to FIG. 7, in use, the portable DVD player 10 is often disposed on a table 150. The display 104 is rotated away from the main body 102 and faces the user. However, because the infrared receiver 106 has a small size and is almost always located in a lower position of the main body 102, the infrared receiver 106 can easily be blocked by a cellphone 160 or other things, such as books, fruits, etc. Accordingly, the control signals sent from the remote controller are blocked.

Therefore, improvements for a portable electronic device are needed in the industry to address the aforementioned deficiency.

### SUMMARY

A portable electronic device includes a main body, a cover, and an infrared receiver. The main body is configured for reading information from an optical disc and generating display signals. The cover is connected to the main body. The screen is configured for receiving the display signals and displaying videos correspondingly. The infrared receiver is arranged at the cover for receiving control signals.

Other advantages and novel features of the present invention will become more apparent from the following detailed description of preferred embodiment when taken in conjunction with the accompanying drawings.

### BRIEF DESCRIPTION OF THE DRAWINGS

FIG. 1 is a schematic diagram showing a portable DVD player in accordance with a first exemplary embodiment.

FIG. 2 is a schematic diagram showing the portable DVD player of FIG. 1, wherein a display of the portable DVD player is rotated to a first direction.

FIG. 3 is a schematic diagram showing the portable DVD player of FIG. 1, wherein a display of the portable DVD player is rotated to a second direction.

FIG. 4 is a schematic diagram showing a portable DVD player in accordance with a second exemplary embodiment.

FIG. 5 is a schematic diagram showing the portable DVD player of FIG. 4, wherein a display of the portable DVD player closed on a main body of the portable DVD player.

FIG. 6 is a schematic diagram showing a conventional portable DVD player.

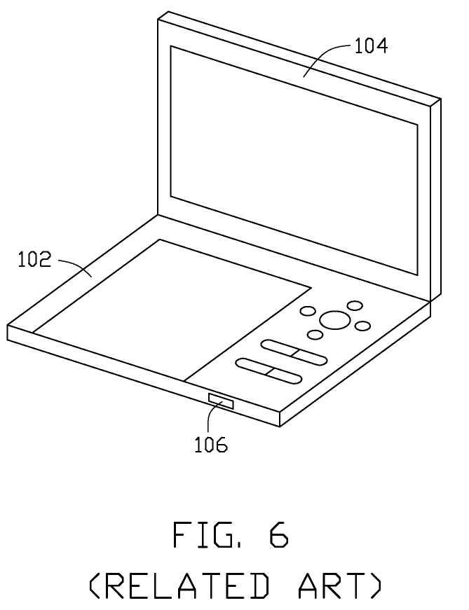

FIG. 7 is a schematic diagram showing the portable DVD player of FIG. 6 in use.

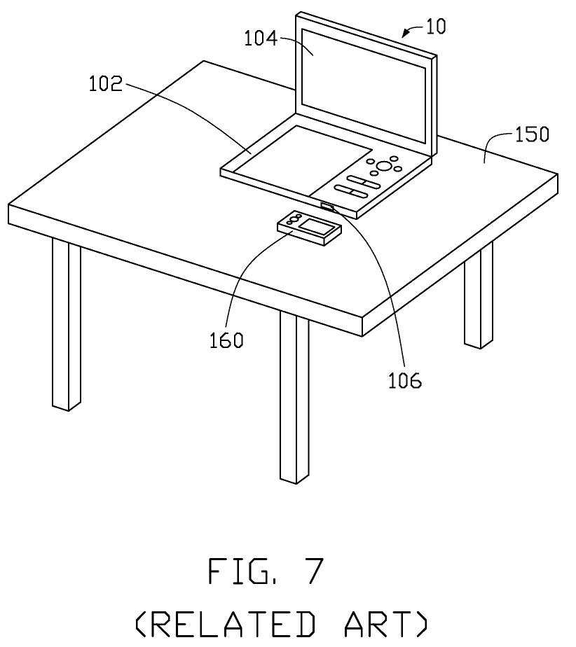

### DETAILED DESCRIPTION

Reference will now be made to the drawings to describe exemplary embodiments of the present portable electronic device.

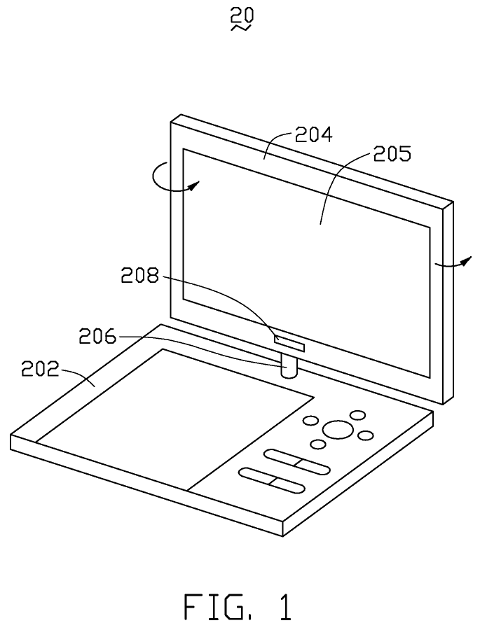

Referring to FIG. 1, a portable digital versatile disc (DVD) player 20 in accordance with a first exemplary embodiment is illustrated. The portable DVD player 20 includes a main body 202, a cover 204, a hinge 206, and an infrared receiver 208. The hinge 206 connects the cover 204 and the main body 202. The hinge 206 is fixed onto a first side of the cover 204, and the cover 204 is rotatable with respect to the main body 202 via the hinge 206. The main body 202 is configured for reading information from an optical disc and generating display signals. The cover 204 includes a screen 205 for receiving the display signals and displaying images or videos correspondingly.

The infrared receiver 208 is arranged in the cover 204 on a same side of the screen 205 and adjacent to the hinge 206. The infrared receiver 208 is configured for receiving control signals from a remote controller (not shown). A data cable (not shown) passes through the hinge to connect the infrared receiver 208 and the main body 202 for transmitting the control signals.

If objects, such as mobile phones, books, etc. are disposed in front of the main body, the infrared receiver 208 will not be blocked because the infrared receiver 208 is disposed at a relative high position with respect to the main body 202.

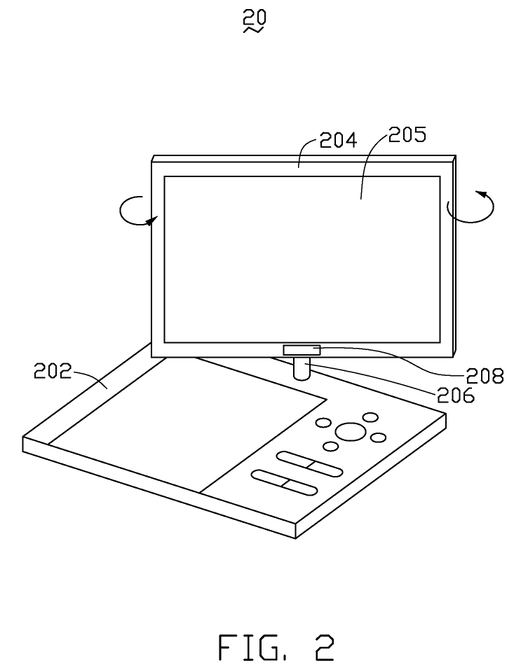

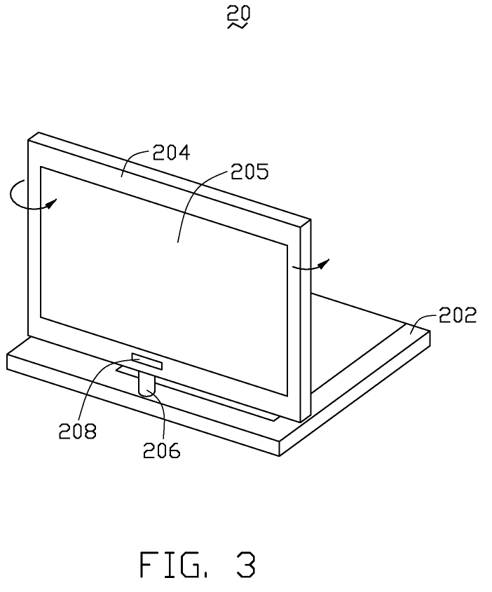

Referring to FIGS. 2 and 3, in use, the cover 204 can be rotated about a vertical axis. In these circumstances, the infrared receiver 208 is also rotated with the cover 204 to face the remote controller (i.e., the user). Therefore, a communication between the infrared receiver 208 and the remote controller will not be interrupted by a rotation of the cover 204.

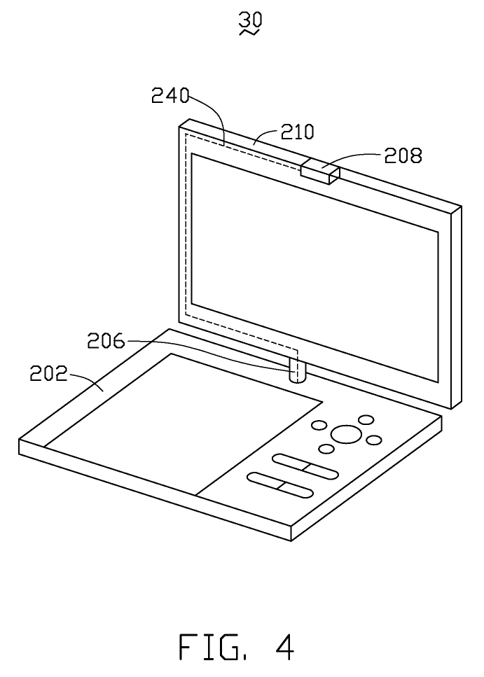

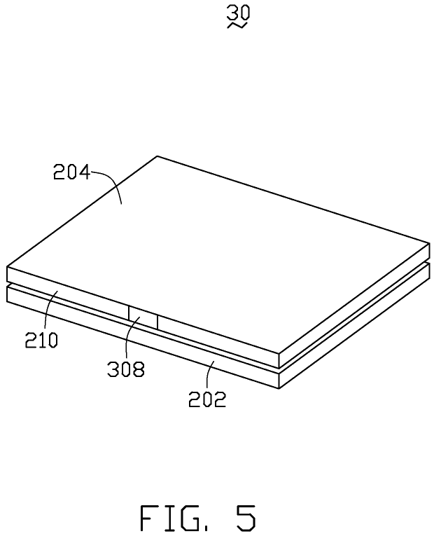

Referring to FIGS. 4 and 5, a portable DVD player 30 in accordance with a second exemplary embodiment is illustrated. In contrast to the portable DVD player 20 of the first embodiment, an infrared receiver 308 is disposed on a second side of the cover 204 opposite to the first side of the cover 204 and away from the hinge 206. In addition, a data cable 240 is disposed in the cover 204 along a peripheral edge, so as to connect the infrared receiver 308 and the main body 202. When the portable DVD player 30 is playing video, the cover 204 is opened from the main body 202 and the infrared receiver 308 locates at an uppermost position of the portable DVD player 30. When the portable DVD player 30 stops playing video and the cover 204 is closed on the main body 202 to play audio files, the infrared receiver 308 is still able to receive the control signals, because a part of the infrared receiver 308 is exposed at a front edge 210 of the cover 204.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A portable electronic device comprising:
a main body for reading information from an optical disc and generating display signals;
a cover connected to the main body and comprising a screen for receiving the display signals and displaying the display signals; and
an infrared receiver arranged in the cover for receiving control signals.

2. The portable electronic device according to claim 1, further comprising a hinge connecting the main body and the cover, and the cover is rotatable with respect to the main body via the hinge.

3. The portable electronic device according to claim 1, wherein the infrared receiver is arranged at a first side of the cover connecting to the main body.

4. The portable electronic device according to claim 1, wherein the infrared receiver is arranged at a second side of the cover, and the second side is opposite to a first side of the cover connecting to the main body.

5. The portable electronic device according to claim 4, wherein a part of the infrared receiver is exposed at a front edge of the cover.

6. The portable electronic device according to claim 4, further comprising a data cable connecting the infrared receiver and the main body.

7. The portable electronic device according to claim 6, wherein the data cable is disposed in the cover along a peripheral edge thereof.

8. The portable electronic device according to claim 3, wherein the first side of the cover is closest to the hinge.
